(19) United States
(12) Patent Application Publication
(10) Pub. No.: US 2004/0117346 A1
(43) Pub. Date: Jun. 17, 2004

(54) Computer-based method and apparatus for repurposing an ontology

(76) Inventors: Kilian Stoffel, Bevaix (CH); Thorsten Kurz, Lausanne (CH); Iulian Ciorascu, Neuchatel (CH); Claudia Clorascu, Neuchatel (CH); Erik Simon, Neuchatel (CH)

Correspondence Address: Simpson & Simpson, PLLC, 5555 Main Street, Williamsville, NY, 14221-5406, US

(21) Appl. No.: 10/665,780

(22) Filed: Sep. 19, 2003

Related U.S. Application Data
(60) Provisional application No. 60/412,163, filed on Sep. 20, 2002.

(51) Int. Cl. G06F 7/00

(52) U.S. Cl. 707/1

(57) ABSTRACT

A common platform computer-based method for repurposing an ontology, comprising the steps of creating an ontology mapping protocol, building a mapping tool based upon the ontology mapping protocol, mapping the ontology onto the common platform using the mapping tool, and, repurposing the ontology based upon the mapping.

### CROSS REFERENCE TO RELATED APPLICATIONS

This patent claims the benefit under 35 U.S.C. §119(e) of U.S. Provisional Application No. 60/412,163, filed Sep. 20, 2002.

### REFERENCE TO COMPUTER PROGRAM LISTING/TABLE APPENDIX

The present patent includes a computer program listing appendix on compact disc. The compact disc contains a plurality of ASCII text files of the computer program listing as follows:

| File Name | File Size kb | Date Created |
|---|---|---|
| config.h | 1 | Aug. 28, 2003 |
| corpus.owl | 2 | Aug. 28, 2003 |
| create_wn_owl | 8 | Aug. 28, 2003 |
| generate_wndata.sh | 2 | Aug. 28, 2003 |
| htsameta.owl | 5 | Aug. 28, 2003 |
| mm.pl | 8 | May 03, 2003 |
| ontology_example.owl | 29 | Aug. 28, 2003 |
| parser_text.py | 2 | May 01, 2003 |
| porter.py | 13 | May 03, 2003 |
| process_results.pl | 2 | Aug. 28, 2003 |
| process_stemmed_word.pl | 2 | Aug. 28, 2003 |
| TREC_collection_example.txt | 5 | Aug. 28, 2003 |
| wn_ant.pl | 233 | May 03, 2003 |
| wn_at.pl | 32 | May 03, 2003 |
| wn_cs.pl | 6 | May 03, 2003 |
| wn_ent.pl | 11 | May 03, 2003 |
| wn_fr.pl | 397 | May 03, 2003 |
| wn_g.pl | 9967 | May 03, 2003 |
| wn_hyp.pl | 2292 | May 03, 2003 |
| wn_mm.pl | 295 | May 03, 2003 |
| wn_mp.pl | 198 | May 03, 2003 |
| wn_ms.pl | 19 | May 03, 2003 |
| wn_per.pl | 225 | May 03, 2003 |
| wn_ppl.pl | 4 | May 03, 2003 |
| wn_s.pl | 6736 | May 03, 2003 |
| wn_sa.pl | 95 | May 03, 2003 |
| wn_sim.pl | 572 | May 03, 2003 |
| wn_vgp.pl | 49 | May 03, 2003 |
| wnowldefs.owl | 9 | Aug. 28, 2003 |
| wp_charset.c | 16 | Aug. 28, 2003 |
| wp_charset.h | 1 | Aug. 28, 2003 |
| wp_reader.c | 43 | Aug. 28, 2003 |
| wp_reader.dsp | 4 | Aug. 28, 2003 |
| wp_reader.dsw | 1 | Aug. 28, 2003 |
| wp_reader.h | 3 | Aug. 28, 2003 |

The computer program listing appendix is hereby expressly incorporated by reference in the present patent.

### FIELD OF THE INVENTION

This invention relates to a method and apparatus for building and repurposing ontologies. More specifically it relates to a method and apparatus for leveraging existing ontologies for unintended applications and the rapid development of new ontologies by leveraging existing ontologies.

### BACKGROUND OF THE INVENTION

Definitions

The following notions are referred to in the patent:

Ontology: In the context of knowledge sharing, an ontology means a specification of a conceptualization. Formally, an ontology is the statement of a logical theory. It is the collection of semantic descriptions of concepts and their relationships for a domain. This set of objects and the describable relations among them are reflected in a representational vocabulary. In an ontology, definitions associate the names of objects and formal axioms constrain the interpretation and well-formed use of the ontology.

Ontology Definition Language: A representational vocabulary for expressing information and associated semantics in a machine processable form, such as, but not limited to, RDF, RDFS, DAML, DAML+OIL, OWL.

Entity: An ontological element defined by an ontology definition language. It can refer to a concept, a relation, an instance, and any kind of statement that can be represented by the ontology definition language. As an illustration, an entity can be interpreted as a resource in the ontology definition languages such as RDF, RDFS, OWL, etc.

Concept: In the context of ontology, a concept denotes a set of entities.

Relation: An entity that links one, two or more entities together.

Individual: Any entity from a concept.

Notations

The following notations are used in the description of the invention:

RDF—Resource Description Framework

RDFS—RDF Schema (RDF Vocabulary Description Language)

DAML—DARPA Agent Markup Language

OIL—Ontology Interchange Language

OWL—Web Ontology Language

N3—Notation 3 Error! Not a valid link.

HTS—Harmonized Tariff Schedule of the United States Annotated

Typically, an ontology consists of two parts: content, i.e., concepts and relationships that exist between these concepts, and rules that define, which relationships are permitted between certain types of concepts. Ontology languages are used to exchange both, content and rules, between different systems. Ontologies provide a shared and common understanding of a domain that can be communicated across people and application systems. Ontologies, therefore, play a major role in supporting information exchange processes in various areas. However, a prerequisite for such a role is the development of a joint standard for specifying and exchanging ontologies.

While ontologies provide great value, they are difficult and costly to build. For example, ICD is probably one of the most used ontologies in the medical domain. It was created in 1893 to provide a structured list of causes of death. With the progress made in the medical domain, ICD had to be adapted to reflect and represent the newly acquired knowledge. Currently, ICD is frequently used to classify patient records according to their principal diagnosis. Many governments demand that hospitals create statistics concerning diagnostics based on the categories defined in ICD. Over time, there has been a considerable shift in the way the ICD categories were originally used (describing causes of death) and how they are now used (describing diagnostics). Importantly, while related, describing a cause of death is different (although related) from describing a diagnosis. This situation represents a non-intended application of an ontology. In situations like this, a user has a choice of using an ontology that doesn't quite fit a desired application, or building a new ontology. Since new ontologies are difficult and costly to build, typically a user will simply use an existing ontology in a domain that while unintended is sufficiently close to be somewhat useful. With the increasing number of available ontologies comes a growing temptation to simply use an ontology for an unintended purpose rather than incur the cost and difficulty of building an ontology from scratch. The result is that users more and more typically interact with useful but not ideal ontologies. The view of the data is often not representative intuitively from the user's point of view.

Similar problems arise when the use of a specific ontology is imposed, i.e., a user might be willing to overcome the difficulty and cost of building a new ontology for a specific need, but the user would not be allowed rebuild or modify an ontology that has been standardized. An example of this is shown in connection with a political decision made in Switzerland. The Swiss government imposed an ontology (TARMED) upon private physicians and hospitals for use to classify their billing information. To enforce the use of the ontology, the government mandated that their reimbursement would depend upon this classification. Originally, though, the TARMED ontology was created by physicians to describe their work. Under the new government mandate, accounts and other administrators will be required to use TARMED to write bills. The problem is that physicians and accountant have a different objective, therefore a different point of view toward the data and their needs from it.

Yet another example is the Harmonized Tariff Schedule (HTS) ontology. The Harmonized Tariff Schedule of the United States Annotated (HTSA) provides the applicable tariff rates and statistical categories for all merchandise that are imported into the United States; it is based on the international Harmonized System, the global classification system that is used to describe most world trade in goods. Unfortunately, government specific needs do not necessarily lead to an ontology that can be intuitively used by a company that has to classify shipments. For example, a “wheelchair” has to be classified as an instance of the class named “Invalid carriages, whether or not motorized or otherwise mechanically propelled” which is a subclass of “Vehicles other than railway or tramway rolling stock, and parts and accessories thereof”.

While a growing number of ontologies exist for more and more applications, there is still a need for an easy way to modify ontologies to fit specific non-intended applications. More specifically, there is a need for a formal system that will allow the repurposed ontologies to be used in new applications without loosening the formal semantics of the original ontology. In other words, to support the creation of views of an existing ontology that correspond to the expectations of users in a specific domain under consideration of the original ontology as an un-modifiable reference system.

Current State of the Art

The current art will be described in the following categories:

1. Ontology languages

2. Ontologies (content of ontology systems)

3. Ontology tools

4. Ontology translation

Ontology Languages

The two main approaches for defining languages for representing Ontologies are the frame-based and the description logic based approach:

Description Logic (DL): DLs describe knowledge in terms of concepts and role restrictions that are used to automatically derive classification taxonomies. The main research efforts in the public domain in knowledge representation is in providing theories and systems for expressing structured knowledge and for accessing and reasoning with it in a principled way. DLs, also known as terminological logics, form an important and powerful class of logic-based knowledge representation languages. They result from early work on semantic networks, and defined a formal semantics for them. DLs attempt to find a fragment of first-order logic with high expressive power, which still has a decidable and efficient inference procedure. Implemented systems include BACK, CLASSIC, KL-ONE, KRIS, LOOM, and YAK. A distinguishing feature of DLs is that classes (usually called concepts) can be defined intentionally in terms of descriptions that specify the properties that objects must satisfy to belong to the concept. These descriptions are expressed using a language that allows the construction of composite descriptions, including restrictions on the binary relationships (usually called roles) connecting objects. Various studies have examined extensions of the expressive power for such languages and the trade-off in computational complexity for deriving is a relationship between concepts in such a logic (and also, although less commonly, the complexity of deriving instances of relationships between individuals and concepts). Despite the theoretical complexity, there are now efficient implementations for DL languages, see, for example, DLP and the FaCT system.

Frame-based systems: The central modeling primitives of predicate logic are predicates. Frame-based and object-oriented approaches take a different point of view. Their central modeling primitives are classes (i.e., frames) with certain properties called attributes. These attributes do not have a global scope but are only applicable to the classes they are defined for (they are typed) and the “same” attribute (i.e., the same attribute name) may be associated with different value restrictions when defined for different classes. A frame provides a certain context for modeling one aspect of a domain. Many additional refinements of these modeling constructs have been developed and have led to the incredible success of this modeling paradigm. Many frame-based systems and languages have been developed, and under the name object-orientation the paradigm has also conquered the software engineering community.

Over the last couple of years more and more research focused on the applicability of ontologies to the WWW. Ontology languages that focus on the WWW are mainly relying on two technologies: XML and RDF.

XML: Modeling primitives and their semantics are one aspect of an Ontology Exchange Language; its syntax is another. Given the current dominance and importance of the WWW, a syntax of an ontology exchange language must be formulated using existing web standards for information representation. As already shown with XOL, XML can be used as a serial syntax definition language for an ontology exchange language. The BioOntology Core Group recommends the use of a frame-based language with an XML syntax for the exchange of ontologies for molecular biology. The proposed language is called XOL. The ontology definitions that XOL is designed to encode include both schema information (meta-data), such as class definitions from object databases, as well as non-schema information (ground facts), such as object definitions from object databases. The syntax of XOL is based on XML and the modeling primitives and semantics of XOL are based on OKBC-Lite.

RDF and RDFS: The Resource Description Framework (RDF) provides a means for adding semantics to a document without making any assumptions about the structure of the document. RDF is an infrastructure that enables the encoding, exchange and reuse of structured meta data. RDF schema (RDFS) provides a basic type schema for RDF. Objects, Classes, and Properties can be described. Predefined properties can be used to model instance of and subclass of relationships as well as domain restrictions and range restrictions of attributes. In relation to ontologies, RDF provides two important contributions: a standardized syntax for writing ontologies, and a standard set of modeling primitives like instance of and subclass of relationships.

There exist two major research initiatives that promoted the investigation of the applicability of ontologies to the WWW: On-To-Knowledge supported by the Information Society Technologies (IST) Program for Research, Technology Development & Demonstration under the 5th Framework Program of the European Council, and DAML supported by DARPA.

In a close collaboration, the researchers of the two projects have shown the usability of ontologies to enrich the functionality of the WEB. The following paragraphs are a short resume of some of the most relevant results.

An important result of the On-To-Knowledge project was the OIL (Ontology Inference Language) or (Ontology Interchange Language). OIL is a layered language; the different layers can be characterized in the following way:

Core OIL coincides largely with RDF Schema (with the exception of the reification features of RDF Schema). This means that even simple RDF Schema agents are able to process the OIL ontologies, and pick up as much of their meaning as possible with their limited capabilities.

Standard OIL is a language intended to capture the necessary mainstream modeling primitives that both provide adequate expressive power and are well understood thereby allowing the semantics to be precisely specified and complete inference to be viable.

Instance OIL includes a thorough individual integration. While the previous layer—Standard OIL—included modeling constructs that allow individual fillers to be specified in term definitions, Instance OIL includes a full-fledged database capability.

Heavy OIL may include additional representational (and reasoning) capabilities.

In the DAML Darpa Project a new language was defined called DAML+OIL. DAML+OIL is a semantic mark up language for Web resources [daml+oil]. It builds on earlier W3C standards such as RDF and RDF Schema, and extends these languages with richer modeling primitives. DAML+OIL provides modeling primitives commonly found in frame-based languages. DAML+OIL (March 2001) extends DAML+OIL (December 2000) with values from XML Schema datatypes. The language has clean and well-defined semantics.

The SHOE project at the University of Maryland at College Park took a similar approach. SHOE is an extension to HTML, which allows web page authors to annotate their web documents with machine-readable knowledge.

SHOE Ontologies declare:

Classifications (categories) for data entities. Classifications may inherit from other classifications.

Valid relationships between data entities and other data entities or simple data (strings, numbers, dates, booleans). Arguments for relationships are typed, either by the simple data that can fill the argument, or with the classification a data entity must fall under in order to fill an argument.

Inferences in the form of horn clauses with no negation.

Inheritance from other ontologies: ontologies may be derived from or extend zero or more outside ontologies.

Versioning. Ontologies may extend previous ontology versions.

HTML pages with embedded SHOE data may:

Declare arbitrary data entities. Usually, one of these entities is the web page itself.

Declare the ontologies, which they will use when making declarations about entities.

Categorize entities.

Declare relationships between entities or between entities and data.

The SHOE Knowledge Annotator is a Java program that allows users to mark-up web pages with SHOE knowledge.

Ontologies

With the availability of Ontology Languages a considerable effort went into the construction of content for these ontology systems (From this point on we will use the term ontology to refer to the content of an ontology system). Ontologies have been known and used for centuries. Many different terms are used to refer to them, such as taxonomies, nomenclatures, knowledge bases. The forms of ontologies range from very simple hierarchical structures to extremely complicated systems containing higher order logical expressions. A comprehensive system that currently exists is the CYC system. The goal of the CYC project was to establish an ontology that would support common sense reasoning.

Furthermore, there exists an IEEE project to create a standardized “Upper Level Ontology” which would represent the most general terms of a generic ontology.

Finally, there is a very wide range of domain specific ontologies from engineering ontologies, over medical ontologies, to business ontologies. Each are tailored toward a specific need in a specific domain.

Ontology Tools

Several tools have been created to work with ontologies:

Jasper is a kind of collaboratively maintained document management system in which retrieval is based on keywords or two-word phrases.

ProSearch searches for relevant documents in large document repositories based on keywords.

Corporum is a tool that tries to extract content representation models in the form of conceptual graphs from natural language texts. Corporum uses models for representing the contents of large bodies of texts and finding documents that are related to an example document.

Protégé-2000 is an integrated ontology editor that permits the modeling of concepts and relations among them as well as entering instances of these concepts. It can be used to design RDF schema and create the corresponding instance data.

OntoEdit is an ontology editor that produces ontologies in its own general XML-based storage format. It supports also F-Logic, and work on an RDF module is being done. The system supports multiple concept names for synonymity and multilingual concept modeling.

Sesame is an RDF Schema-based Repository and Querying facility. Sesame supports highly expressive querying of RDF data and schema information, using an OQL-style query language, called RQL. A typical query in RQL looks like:

select $X, $Y from {:$X} http://www.icom.com/schemal.rdf#paints {:$Y}

IBROW has as an objective to develop intelligent brokers that are able to distributively configure reusable components into knowledge systems through the WWW. The WWW is changing the nature of software development to a distributive plug & play process, which requires a new kind of managing software: intelligent software brokers. IBROW will integrate research on heterogeneous DB, interoperability and Web technology with knowledge-system technology and ontologies.

Ontology Translation

Another relevant component of an ontology building system or platform is the translation of ontologies. There exist several approaches to ontology translation. The following represent two of many ontology translation systems in the public domain:

Ontology Calculus: Ontology Calculus is a “classical” approach of handling the problem of mapping between ontologies through the definition of a formal calculus. This project was realized at the University of Stanford.

XSL-T: XSL-T permits the definition of the translation of one XML document into another. This approach is especially interesting with the major influence technologies such as RDF/DRFS, XML/XMLS had in the last couple of years on the development of ontologies as well as on the technologies related to ontologies.

What is needed is a system that facilitates the repurposing of existing ontologies for new uses, facilitates the mapping of new ontologies back to existing ontologies, and facilitates administrative management of ontology building systems.

### SUMMARY OF THE INVENTION

In one embodiment, the present invention is a common platform computer-based method for repurposing an ontology, comprising the steps of creating an ontology mapping protocol, building a mapping tool based upon the ontology mapping protocol, mapping the ontology onto the common platform using the mapping tool, and, repurposing the ontology based upon the mapping.

The invention also comprises a computer-based method for repurposing an ontology, including the steps of creating an ontology mapping protocol, mapping the ontology onto a common language using the ontology mapping protocol, and, repurposing the ontology based upon the mapping.

The invention further comprises a computer-based method for repurposing an ontology, including the steps of mapping the ontology onto a common language using an ontology mapping protocol, and, repurposing the ontology based upon the mapping.

The invention also comprises a computer-based method for repurposing an ontology, including the steps of mapping the ontology onto a common language, and, repurposing the ontology based upon the mapping.

The invention further comprises a computer-based method for repurposing a first ontology, including the steps of mapping the first ontology onto a common language, and, repurposing the first ontology based upon the mapping, thereby creating a second ontology in a manner such that the second ontology maps back to the first ontology.

The invention also comprises a computer-based method for repurposing a first ontology, including the steps of mapping the first ontology onto a common language, and, repurposing the first ontology based upon the mapping and known repurposing limitations to create a second ontology, wherein the second ontology maps back to the first ontology.

The invention further comprises a computer-based method for coordinating corroboration between at least two separate entities with respect to at least one ontology, including the steps of controlling access rights of the at least two separate entities to parts of the at least one ontology, and, defining how the access rights are granted.

A primary objective of the invention is to provide a common platform computer-based method for repurposing an ontology, comprising the steps of creating an ontology mapping protocol, building a mapping tool based upon the ontology mapping protocol, mapping the ontology onto the common platform using the mapping tool, and, repurposing the ontology based upon the mapping.

This and other objects, features and advantages of the present invention will become readily apparent to those having ordinary skill in the art upon reading the detailed description of the invention in view of the drawings and attached computer software listing.

### BRIEF DESCRIPTION OF THE DRAWINGS

FIG. 1 is a general overview of the general ontology management system of the present invention;

FIG. 2 illustrates the preprocess procedure of the present invention;

FIG. 3 illustrates a description of representative information that can be used to generate an ontology;

FIG. 4 illustrates a small set of resources for a WordNet ontology;

FIG. 5 illustrates the management procedure for the present invention;

FIG. 6 illustrates the communication scheme between the client procedure and the management procedure;

FIG. 7 illustrates an example where two users are using the same ontology system;

FIG. 8 is a drawing similar to that of FIG. 7, but with the reference ontology replaced by the WordNet ontology of FIG. 4;

FIG. 9 is a drawing similar to that of FIG. 8, but extended with User B's ontology;

FIG. 10 is a legend which recites the notations used in describing the User Management mechanism of the present invention;

FIG. 11 illustrates the hierarchy of classes in the User Management mechanism;

FIG. 12 is an illustration of the MetaObjects hierarchy;

FIG. 13 illustrates the MetaObjects subclasses in detail;

FIG. 14 illustrates rights class instances;

FIG. 15 illustrates AccessList class;

FIG. 16 illustrates GrantRights class;

FIG. 17 illustrates GrantAccessList class;

FIG. 18 illustrates object relations;

FIG. 19 illustrates an example test case; and,

FIG. 20 illustrates how User “B” accesses permissions on Ontology “W”.

### DETAILED DESCRIPTION OF THE PREFERRED EMBODIMENTS

Process Workflow

Overview

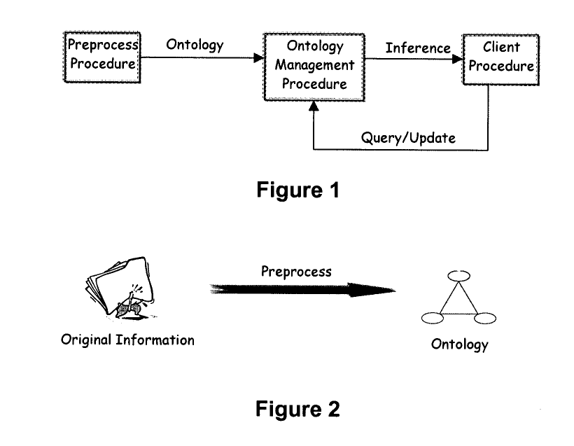

The following process workflow describes an Ontology Management System and its internal consecutive steps followed in order to store in a machine processable form the data and knowledge contained into the original information. A general overview over the entire process can be visualized in FIG. 1.

The Preprocess Procedure creates a knowledge base (ontology) specified in an ontology definition language. The information necessary to create the ontology can be extracted from a collection of documents or it can be obtained from another system. The ontology generated by the Preprocess Procedure is taken over by the Management Procedure, which has the responsibility to store, operate, and inference over the imported ontology. The Client Procedure can access the ontology administrated by the Management Procedure through an interface protocol or it can directly access the data. Each described procedure can be a complete system or a component of an existing one.

Preprocess

The Preprocess Procedure develops an ontology regarding one or more specific domains. It extracts and formats the knowledge from the original information into a knowledge base defined in an ontology definition language. The procedure is sketched in FIG. 2.

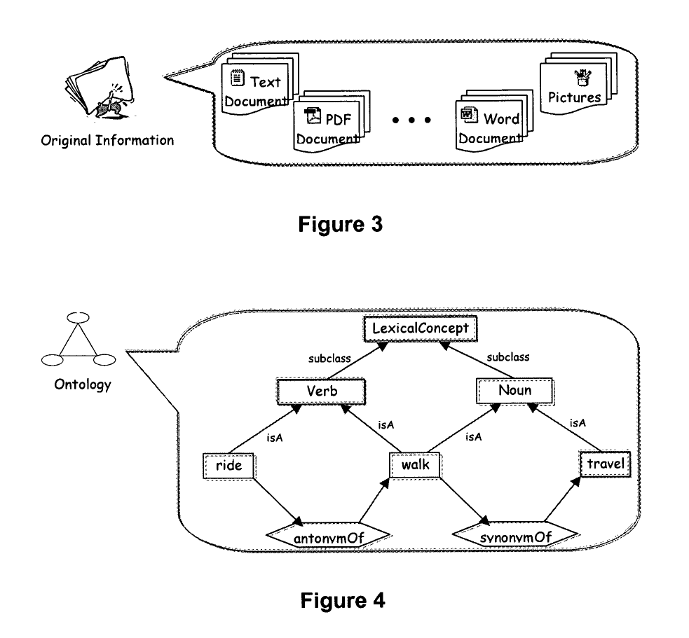

The native information, illustrated in FIG. 3, for generating the ontology can be obtained from a collection of documents or automatically generated. The documents comprising the necessary data can exist in both text and/or binary format. The data from these documents may be structured or not, depending on the document format and the contained information. If the original data is already an ontology defined in an ontology definition language, the preprocess procedure can be omitted in the process workflow.

The original data will be structured as an ontology described by an ontology definition language. The resulting ontology can comprise the whole or a part of the initial information. The translation from the original data to the corresponding ontology can be made by a component from the current system or by another system. Different ontologies can be obtained from same data, depending on the usefulness of the information that has to be analyzed by the final user.

The resulting ontology is a set of entities defined in an ontology definition language. An entity defined in the ontology describes a concept, a relation, or an instance of a concept or relation. An entity can be associated with (but not limited to) one or more concepts derived from the information from the original data. Also a group of entities may describe a single concept suggested by the information from the original data. Other entities that are not directly or indirectly related to the original information can also be included into the ontology. Inside the ontology, the entities can be linked one to each other through other entities, referred as relations. The entire ontological structure comprises the information and the meaning extracted from the original data. It forms a machine processable knowledge base without losing the semantics provided by ontology definition language.

As an illustration as to how the Preprocess Procedure works, two procedures are presented: HTS Parser Component from HTS System and WordNet Converter Module from WordNet System.

In both projects, the original information is collected from existing documents. In the case of HTS System, the data is extracted from semi-structured WordPerfect documents, where as the WordNet System constructs its ontology from logically formatted text documents. For other systems different types of documents (e.g., Microsoft Word, PDF, images or other multimedia types etc.) can be considered.

Depending on the document format and information required by the system, a different preprocess procedure can be used.

Seen as part of a larger system, the preprocess step can be designed as a distinct module (e.g., the HTS Parser) or as a separate application (e.g., WordNet Converter). It may communicate with the main system through an interface that allows the “passing” of new created knowledge base to be further analyzed. The development language can be any compilable or scripting language (e.g., C, C++, Java, Lisp, bash commands, perl, python, etc.).

The ontology generated by the preprocess procedure describes the concepts (or part of them) and relations between concepts (or part of them) induced by the information comprised into original data. In the case of existing ontology definition languages (e.g., RDF, RDFS, DAML+OIL, OWL, KIF, N3, etc.), these concepts and relations are referred in the new ontology as resources. As an illustration, FIG. 4 shows a small set of resources defined in the WordNet ontology.

In this example each resource defines a human understandable concept (Noun, similarTo, etc.).

Ontology Management Procedure

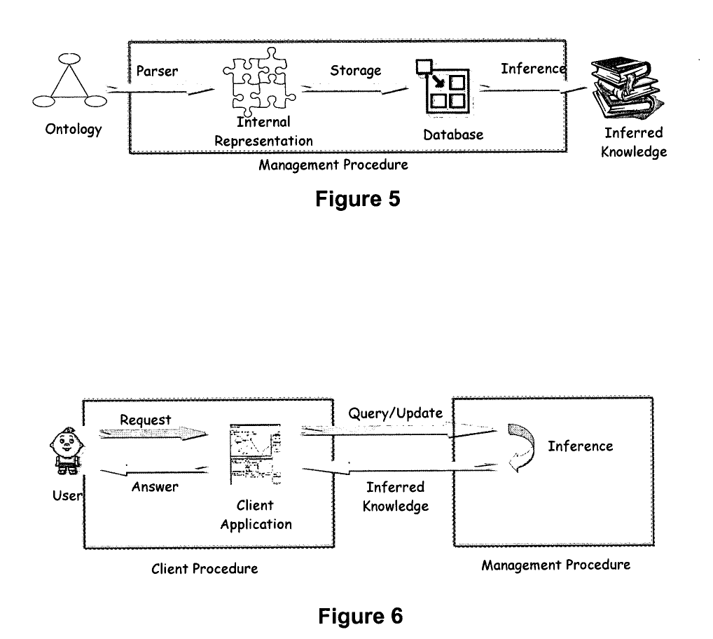

The Management Procedure provides the functionality to parse, store and analyse the structure and the semantics defined by an ontology expressed in an ontology definition language. FIG. 5 highlights the responsibility of the Management Procedure.

Internally, the Management Procedure can be divided in multiple components (e.g., a Parser Module for parsing the ontology, a Storage Module for saving the ontology into an internal format, an Inference Module to query and inference over the data, a Management Module that controls the other components, etc.). Each component can be designed as a black-box module that provides an interface for communicating with other components or it can be completely or partially integrated into other modules.

The ontology imported by the Management System can be the content of an ontology created by a Preprocess Procedure or it can be the ontological information provided by the Client Procedure. Considering this, the ontology imported by the Management Procedure may be a complete ontology or ontological information in addition to an existing one. This gives the possibility to extend an existing ontology with new definitions.

The Parsing operation converts the information described by an ontology into an internal representation. During this process syntactical and some semantic checks are performed. The internal representation depends on the design of the Management Procedure. As an illustration in the WordNet example the data was internally represented in Ntriple format, but other data structures are also possible.

In order to be able to infer over the information extracted from the imported ontology, the internal data is stored in a database format. The persistent storage assures the reusability of the imported ontology without reloading the data. This can be a relational database (MySQL, Oracle, DB2, etc.), an object-oriented database, a simple text document or any type of user-defined stored database (hashes, B-trees, etc.). For fast access a memory-based storage can be used (B+-tree or any other user defined data structure used for storing the data). The database used by the Management Procedure can be either a persistent database or memory-based database.

The inference engine queries over the data stored in the database and discovers new knowledge based on the axioms and semantics captured from the imported ontology. It provides a query language for retrieving and interpreting information handled by the Management Procedure. This query language can be designed as an API and/or as a distinct language (e.g., RDQL). A scripting language could also be integrated and provided as part of the query language (e.g., ICI).

The Management Procedure may support the reference ontologies described in infra. This requires a special mechanism to handle reference ontologies and user-defined ontologies. Also, the inference should be able to control the research space over the existing ontologies.

The Management Procedure can be designed as a complex unique component that provides all the functionality. It can be written and can provide an API interface in any programming language (C, C++, Java, script-type languages, etc.). Also, a component-based architecture can be achieved by defining an interface for one or more modules (Parser, Storage, Inference, etc.)

Client Procedure

The Client Procedure conducts the communication between user and the Ontology Management Procedure. It takes over the requests coming from the user and formats them in order to be send to the Ontology Management Procedure. Depending on the type of request, the Ontology Management Procedure infers over the knowledge base or updates the existing ontology. The result is send back to the Client Procedure that translates them and gives the answer in a human readable form. This process can be visualized in FIG. 6.

The Client Procedure consists in a Client Application designed as a standalone application or as part of a more complex system. Almost every type of programming language can be used for developing it (C, C++, Java, lisp, perl, bash commands, etc.). As an illustration, the Client Application can provide a Web GUI for an user-friendly interface, but other options can also be considered (C++API, COM, JAVA API, etc.). The interface of the Client Application can also be extended with other functionalities (e.g., exporting the whole ontology in different formats—RDFS, OWL, etc.).

Reference Ontology claim

Overview

In order to make a system (e.g., Ontology Management System described in Section 1) to control the information validity for the system ontology, we define the concept of a Reference Ontology. A reference ontology can be seen as the main definitions of concepts, relations and instances that describe a domain of interest. A user can add his own information to the references system; however he is not allowed to change the reference ontology. However all the modification he adds have to be mapped back to the original reference ontology

Description

We say that an ontology handled by a system is a reference ontology with respect to that system if it can not be changed by removing or modifying the information and semantics comprised in that ontology, but can be extended by an user-defined ontology.

Also, a system that supports a reference ontology is defined as a system that doesn't allow any changes concerning removing or modifying the information and semantics comprised in a reference ontology and accepts only that extensions to the system ontology that are directly or indirectly linked with at least one reference ontology of the ontology system. In addition, a system that supports reference ontologies should be able to restrict the inference made over the system ontology to one or more reference ontologies such that the results to be deducted depend only from the information and semantics provided by the considered reference ontologies.

Since the system can be limited to conduct the inference only over the reference ontology, a user can always return to the base knowledge, avoiding the information added.

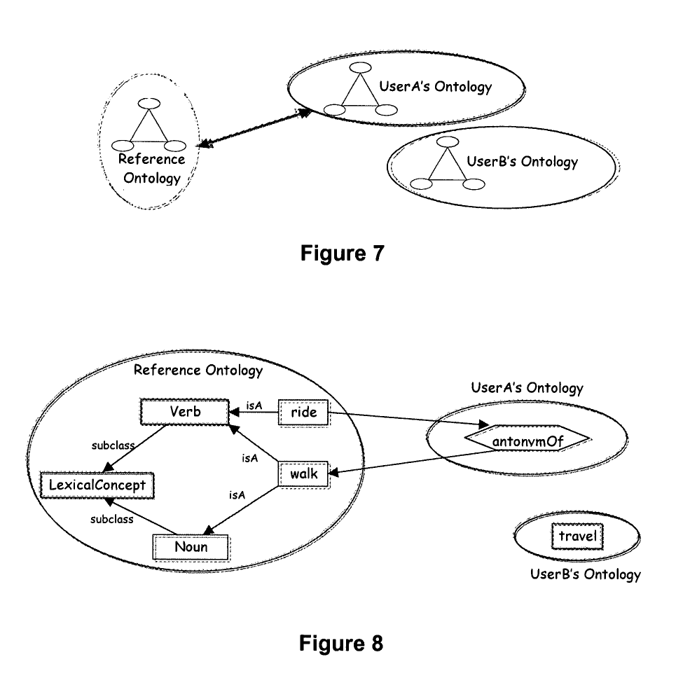

In the example shown in FIG. 7, two users are using the same ontology system.

UserB is allowed to make changes to his ontology as he wishes as his ontology is not referring to a reference ontology. UserA however, has to respect the reference ontology as his ontology is linked to the Reference Ontology. Both users have the right to inference over the whole ontology (comprising the reference ontology plus the information added by the users) or only over the reference ontology.

In FIG. 8, we consider the WordNet Ontology example illustrated in FIG. 4.

The reference ontology comprises the definitions of LexicalConcept, Verb, Noun, ride and walk entities and the relations among them. Using these entities, UserA defines its own antonymOf relation between ride and walk, extending the definitions of the reference ontology. UserA can always infer over the whole ontology, or only over the reference ontology, without considering the information added. On the other hand, UserB defines an ontology containing the entity travel not related to the reference ontology. He/she can interrogate the reference ontology but he/she cannot add his/her own ontology.

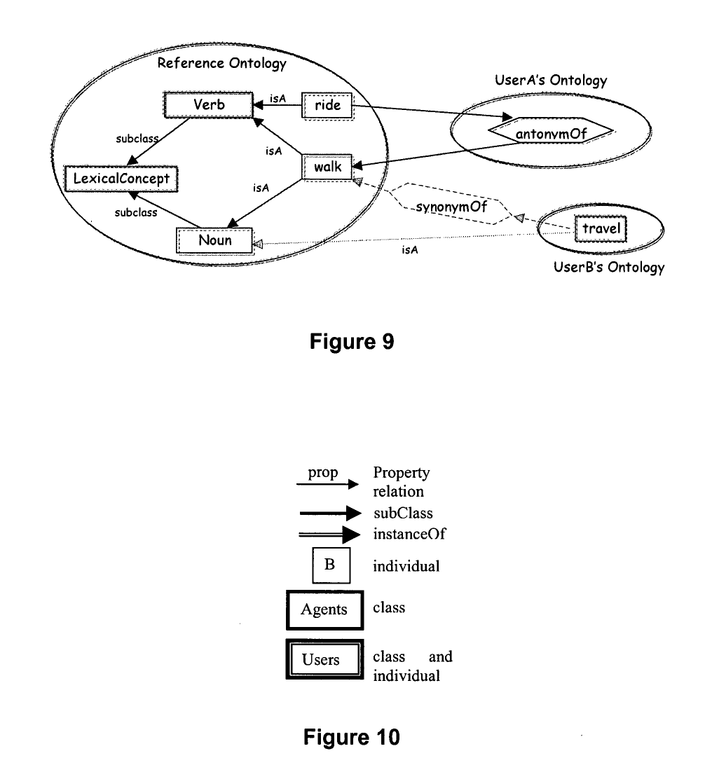

As an illustration, in order to be able to append his/her definitions to the reference ontology, he could link the travel entity to the Noun concept or to define a synonymOf relation between travel and walk entities or to add any other definitions that will relate travel with entities from the reference ontology (FIG. 9).

A system that supports reference ontologies assures the consistency of the knowledge kept in the system ontology. There are different techniques for separating the reference ontology from other data. One such mechanism can be realized by marking each entity of the reference ontology. This can be achieved by using a system ontology that defines a relation fromRefOntology: Entity→BooleanValue that relates each entity of the reference ontology with the boolean value true and user-defined entities with the boolean value false. More generally, the fromRefOntology can be defined such that each ontology (reference or user-defined) to be linked to an ontology identifier, given the system the possibility to identify the type (reference or not) and the owner of each defined entity.

User Management claim

Overview

When multiple users should have access and manage a knowledge repository, the security becomes a very important part of the system. The security is handled by restricting the access of the users on subparts of the data and also refining the type of access (only read, or read and write, delete, etc). Since defining the rights on single users can easily become a hard task for an administrator, the system allows the possibility to define rights on groups of users. The system also allows the rights to be applied on individual resources, or on sets of resources that are grouped together using some criteria.

If the knowledge base is fairly large and if there are many users in the system, even using the groups and collections of resources, the administrative task becomes too expensive for a single administrator. As a solution to this problem, the system implements a mechanism for delegating administrative rights for subparts of the system to some users of the system, such that they become local administrators on their group and collection of resources. They can even “subdelegate” other users for smaller parts of their own subparts.

In the next section this mechanism will be described and examples will be given where necessary.

Description

We will begin the description of the “User Management” mechanism by defining the terms that we use, and then give some examples of how the access rights can be used in the system. The notations used throughout the chapter are described in FIG. 10.

Agents

“Agents” is the class of all users and groups of users that can be used as beneficiary of the rights assignation.

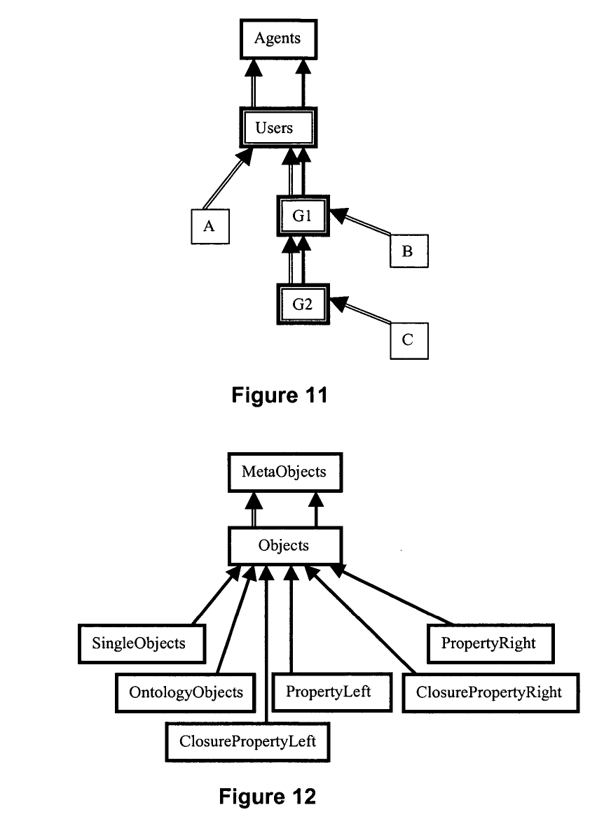

In FIG. 11 the hierarchy of the classes is shown. There are two notions in the hierarchy.

Users—is the class of all the users of the system and can also be used as the group of all users in the system because it is also an instance of the “Agents” class. A user being an individual entity that can access the system resources, can query or modify the knowledge repository.

Groups—a group is simply a set of users. It is defined as a subclass of “Users” class or as a subclass of another group. If the group is to be used at the same time as an agent, it should be also an instance of its super class.

In conclusion, an agent could be a user or a group instance. A given user U will “match” a given agent A if and only if the agent A is the user U or the agent A is a group and U is an instance of that group.

MetaObjects

The system is able to give access rights to a set of objects from the knowledge repository. It can identify this set of objects using a hierarchy of classes and it's instances. The top class of this hierarchy is the “MetaObjects” class. A visual representation of this hierarchy can be found in FIG. 12.

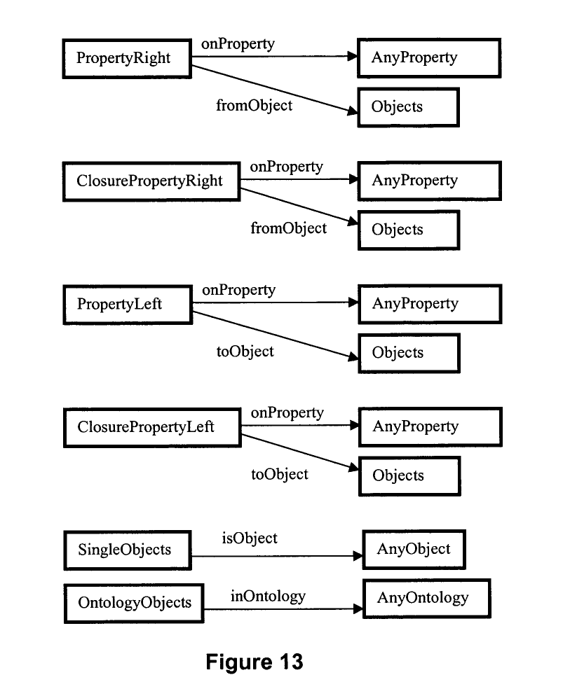

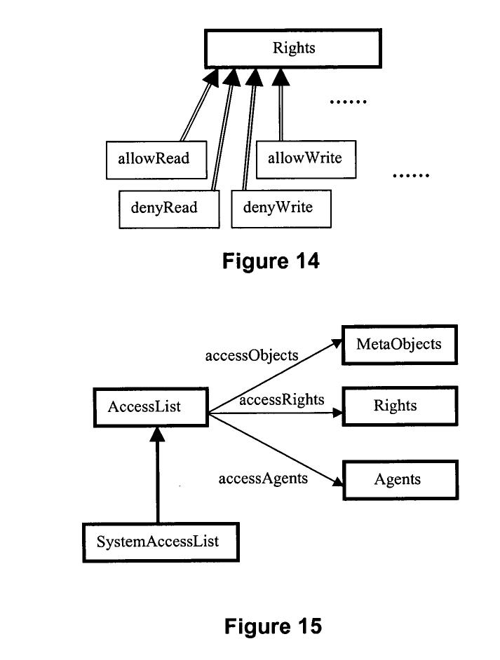

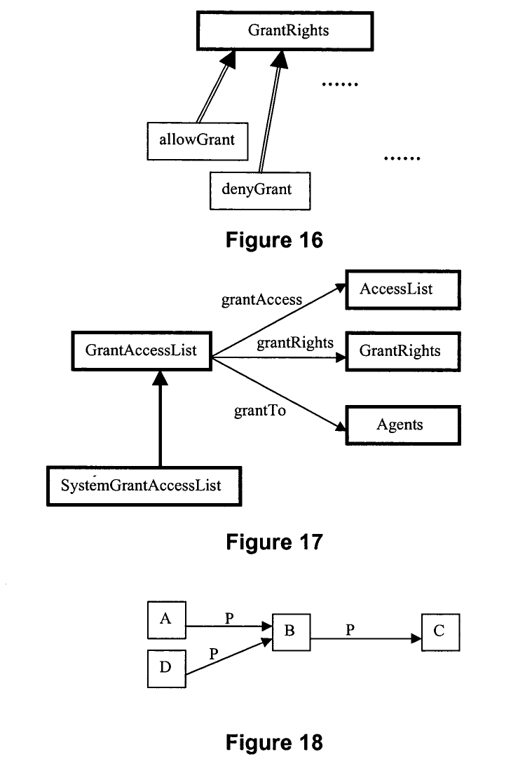

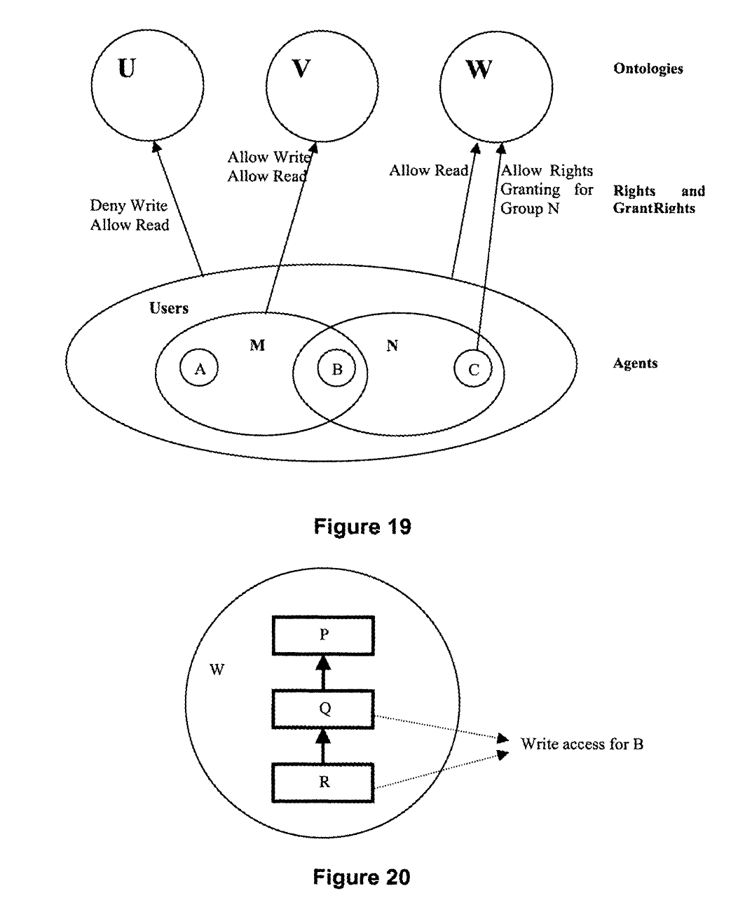

An object has the form <namespace>#<name> where <namespace> usually describes an ontology. The most general set of objects that can be specified in an access list is the set of all objects from the knowledge repository. This set is named “Objects” and is a subclass of “MetaObjects” class as well as an instance of it. There are further specializations of this class, used for various types of sets that can be specified and we give the description of some of them. They are also graphically shown in FIG. 13.

SingleObjects—this is a “this(these) object(s)” class, an instance of the “SingleObjects” class will match the objects it specifies as values for the “isObject” property.

OntologyObjects—this is an “all from that(those) specific ontology(ies)” class, an instance of the “OntologyObjects” class should specify one or more “AnyOntology” instance as a value of the “inontology” property and will match any object that belongs to the specified ontology(ies).

PropertyRight—this is an “objects related to some objects directly through a property as the right side” class, an instance of this class should specify one or more properties as values to the “onproperty” property and one or more “Objects” instances as values to the “fromObject” property. An instance will match any objects that are related through at least one of the specified properties to one object that matches at least one of the specified “fromObject” meta objects.

ClosurePropertyRight—this is an “objects related to some objects through a chain of properties as the right side” class, an instance of this class should specify one or more properties as values to the “onproperty” property and one or more “Objects” instances as values to the “fromObject” property. An instance will match any objects that are related through a path of specified properties to one object that matches at least one of the specified “fromObject” meta objects. The chain has zero or more links (i.e., it could have no link at all, in which case all the objects that match “fromObject” values will match the “ClosurePropertyRight” instance).

PropertyLeft—this is an “objects related to some objects directly through a property as the left side” class, an instance of this class should specify one or more properties as values to the “onproperty” property and one or more “Objects” instances as values to the “toObject” property. An instance will match any objects that are related through at least one of the specified properties to one object that matches at least one of the specified “toObject” meta objects.

ClosurePropertyLeft—this is an “objects related to some objects through a chain of properties as the left side” class, an instance of this class should specify one or more properties as values to the “onProperty” property and one or more “Objects” instances as values to the “toObject” property. An instance will match any objects that are related through a path of specified properties to one object that matches at least one of the specified “toObject” meta objects. The chain has zero or more links (i.e. it could have no link at all, in which case all the objects that match “toObject” values will match the “ClosurePropertyLeft” instance).

An example of the PropertyRight, ClosurePropertyRight, PropertyLeft and ClosurePropertyLeft is provided later in this description.

Access Lists

Rights

After identifying the sets of objects on which the access applies, the agents to whom the access rights are given, we need to identify the different types of rights to apply (like: read, change, append, etc), and the way that they are applied (like “deny” or “allow”). Some individuals of the “Rights” class are: “allowRead”, “denyRead”, “allowWrite”, “denyWrite”, etc.)

AccessList

An instance of this class unites together the meta objects, the agents and the access rights with the meaning that the specified agents has the specified rights over the specified objects. The properties that link an “AccessList” instance with other instances are:

a. “accessObjects” for meta objects (i.e. instances of “MetaObjects” class)

b. “accessRights” for the selected rights

c. “accessAgents” for the agents to whom the rights should be applied

There is a subclass of the “AccessList” class that holds the instances that are active in the system. This subclass is named “SystemAccessList”.

GrantRights

In order to create access lists and to give some access rights on some objects to some agents, a user should have the grant right. When giving the grant right to a user, one can also specify if the user can give the grant right to other agents. So two “GrantRights” instances are “allowGrant”, “denyGrant”, but there can be also other instances in this class.

GrantAccessList

An instance of this class unites together the access lists, the grant rights and the agents with the meaning that the specified agents can create access lists that match the given ones, and also has the specified grant rights on the specified access lists. The properties that link a GrantAccessList” instance with other instances are:

a. “grantAccess” for access lists

b. “grantRights” for the selected grant rights

c. “grantTo” for the agents to whom the grant rights are be applied

There is a subclass of the “GrantAccessList” class that holds the instances that are currently active in the system. This subclass is named “SystemGrantAccessList”.

### EXAMPLES

We use the name “S” throughout the example to name the built-in ontology that has the “User Management” classes and individuals. Following are two explained examples.

### MetaObject Example

In order to better understand the meta objects “match” mechanism a small example will be given. Let us suppose that we have a property “P” and five individuals that are linked through the property “P”. Now if we have a meta object “obj” defined by:

<#obj> is_a <S#PropertyRight>; <S#onProperty><#P>; <S#fromObject><#A>.

The meta object will match all the objects that are values of property “P” starting from A after exactly one step. As a result, only the object “B” will be matched.

If we would define “obj” as:

<#obj> is a <S#ClosurePropertyRight>; <S#onProperty><#P>; <S#fromObject><#A>.

then all “accessible through P” objects starting from A would match, including “A” itself. “A”, “B” and “C” will match the meta object “obj”.

For “PropertyLeft” and “ClosurePropertyLeft” the match mechanism is similar except the fact that the left side of the given properties will be matched.

So, if “obj” would be defined as:

<#obj> is a <S#ClosurePropertyLeft>; <S#onProperty><#P>; <S#fromObject><#B>.

then “B”, “A” and “D” will match, but only “A” and “D” will match if we would have used “PropertyLeft” instead of “ClosurePropertyLeft”.

### Access List Example

The second example will give an idea on how the user management shall be used in the system.Let us suppose that there are three different users in the system, “A”, “B” and “C”. Thus, all three are instances of the “Users” class. There are also two groups “M” and “N”, the first group contains the “A” and “B” users and the second one contains “B” and “C” users.

Let us also suppose that the knowledge repository is formed by three ontologies “U”, “V” and “W”.

Firstly, let's see how to say that we want to deny write and allow read for any one to the “U” ontology. Here is the N3 notation for it:

[ <S#accessObjects> [ a <S#OntologyObjects>; <S#inOntology> <U> ];

<S#accessRights> <S#denyWrite>, <S#allowRead>;
<S#accessAgents> <S#Users>

] a <S#SystemAccessList> .

With brackets we are allowed to define anonymous individuals. In the previous example we used it twice, once for defining the SystemAccessList individual and secondly for defining an anonymous “OntologyObjects” instance for the ontology “U”. The meaning of the statement is to define an anonymous node that has the property <S#accessObjects> with the value the anonymous “OntologyObject” previously described. Also this anonymous node has the “accessRights” property with the values <S#denyWrite> and <S#allowRead>, the <S#accessAgents> property with the value <S#Users> and it is of type <S#SystemAccessList>.

Next, we shall present the statement that will grant the write and read rights to the group “M” for the ontology “V”.

[ <S#accessObjects> [is_a <S#OntologyObjects>; <S#inOntology><V> ];

<S#accessRights> <S#allowWrite>, <S#allowRead>;
<S#accessAgents> <S#M>

] is_a <S#SystemAccessList> .

In order to allow all the users to read the “W” ontology we use:

[ <S#accessObjects> [is_a <S#OntologyObject>; <S#inOntology><W> ];

<S#accessRights> <S#allowRead>;
<S#accessAgents> <S#Users>

] is_a <S#SystemAccessList> .

In order to give the “C” user the rights to grant read/write permissions for the ontology “W” to the group “N” (and particular users) we can use the following construct:

[ <S#grantAccess> [is_a <S#AccessList>;

<S#accessObjects> [is_a <S#OntologyObjects>;

<S#inOntology> <V> ];

<S#accessRights> <S#allowWrite>, <S#allowRead>;
<S#accessAgents> <S#M>];

<S#grantRights> <S#allowGrant>;
<S#grantTo> <S#C>;
] is_a <S#SystemGrantAccessList>.

Note that the anonymous access list used here is no longer a member of “SystemAccessList” class but only a member of “AccessList” because it is not active in the system, it only means that the user C can create “active” access lists that matches this access list. The “allowGrant” individual as a value of “grantRights” property means that the user “C” can himself delegate other users (only from group M) to be able to grant rights in the specified domain.

To further explain the granting mechanism, we can suppose that there are three classes in the “W” ontology, “P”, “R” and “Q”.

Now let's suppose that the user “C”, which is the “manager” inside the “N” group, for the “W” ontology decides that the user “B” (another user from “N” group) should be granted write access only to the class “R” and all its subclasses. To achieve this he will have to make the following statement:

[ <S#accessObjects> [is_a <S#ClosurePropertyLeft>;

<S#onProperty> <subClassOf>;

<S#toObject> [is_a <S#SingleObjects>; <S#isObject>
<#R>]

];

<S#accessRights> <S#allowWrite>;
<S#accessAgents> <S#B>

] is_a <S#SystemAccessList> .

Note that for the “R class and all its subclasses” we used the ClosurePropertyLeft for the property “subClassOf” and as the starting point we created an anonymous meta object that matches the class “R”. Also, whenever a user is given the grant permission he is automatically given the read right on the specified domain (set of objects), so he can be able to read the objects on which he will give permission to other users. It may be that he could not have the write permission but still have the right to give write permission to other users.

Finally, although the method of the invention has been described above in detail, it should be appreciated that the invention also comprises an apparatus, namely, a general purpose computer specially programmed to implement the various steps of the method as outlined and recited in the claims. More specifically, the apparatus is a general purpose computer specially programmed with the software included in the attached listing on compact disc.

Thus it is seen that the object of the invention is efficiently obtained, although modifications and changes to the invention should be obvious to those having ordinary skill in the art, and these modifications are intended to be within the scope of the claims.

What is claimed is:

1. A common platform computer-based method for repurposing an ontology, comprising:
creating an ontology mapping protocol;
building a mapping tool based upon said ontology mapping protocol;
mapping said ontology onto said common platform using said mapping tool; and,
repurposing said ontology based upon said mapping.

2. A computer-based method for repurposing an ontology, comprising:
creating an ontology mapping protocol;
mapping said ontology onto a common language using said ontology mapping protocol; and,
repurposing said ontology based upon said mapping.

3. A computer-based method for repurposing an ontology, comprising:
mapping said ontology onto a common language using an ontology mapping protocol; and,
repurposing said ontology based upon said mapping.

4. A computer-based method for repurposing an ontology, comprising:
mapping said ontology onto a common language; and,
repurposing said ontology based upon said mapping.

5. A computer-based method for repurposing a first ontology, comprising:
mapping said first ontology onto a common language; and,
repurposing said first ontology based upon said mapping, thereby creating a second ontology in a manner such that said second ontology maps back to said first ontology.

6. A computer-based method for repurposing a first ontology, comprising:
mapping said first ontology onto a common language; and,
repurposing said first ontology based upon said mapping and known repurposing limitations to create a second ontology, wherein said second ontology maps back to said first ontology.

7. A computer-based method for coordinating corroboration between at least two separate entities with respect to at least one ontology, comprising:
controlling access rights of said at least two separate entities to parts of said at least one ontology; and,
defining how said access rights are granted.

8. An apparatus for repurposing an ontology, comprising:
means for creating an ontology mapping protocol;
means for building a mapping tool based upon said ontology mapping protocol;
means for mapping said ontology onto said common platform using said mapping tool; and,
means for repurposing said ontology based upon said mapping.

9. An apparatus for repurposing an ontology, comprising:
means for creating an ontology mapping protocol;
means for mapping said ontology onto a common language using said ontology mapping protocol; and,
means for repurposing said ontology based upon said mapping.

10. An apparatus for repurposing an ontology, comprising:
means for mapping said ontology onto a common language using an ontology mapping protocol; and,
means for repurposing said ontology based upon said mapping.

11. An apparatus for repurposing an ontology, comprising:
means for mapping said ontology onto a common language; and,
means for repurposing said ontology based upon said mapping.

12. An apparatus for repurposing a first ontology, comprising:
means for mapping said first ontology onto a common language; and,
means for repurposing said first ontology based upon said mapping, thereby creating a second ontology in a manner such that said second ontology maps back to said first ontology.

13. An apparatus for repurposing a first ontology, comprising:
means for mapping said first ontology onto a common language; and,
means for repurposing said first ontology based upon said mapping and known repurposing limitations to create a second ontology, wherein said second ontology maps back to said first ontology.

14. An apparatus for coordinating corroboration between at least two separate entities with respect to at least one ontology, comprising:
means for controlling access rights of said at least two separate entities to parts of said at least one ontology; and,
means for defining how said access rights are granted.
